(19) United States
(12) Patent Application Publication
(10) Pub. No.: US 2016/0071091 A1
(43) Pub. Date: Mar. 10, 2016

(54) METHOD AND SYSTEM FOR REAL TIME CONSUMER TRANSACTION TRACKING

(71) Applicant: MASTERCARD INTERNATIONAL INCORPORATED, Purchase, NY (US)

(72) Inventor: Leland ENGLEBARDT, New York, NY (US)

(73) Assignee: MASTERCARD INTERNATIONAL INCORPORATED, Purchase, NY (US)

(21) Appl. No.: 14/482,485

(22) Filed: Sep. 10, 2014

(51) Int. Cl. G06Q 20/34; G06Q 20/32; G06Q 20/20; G06Q 20/38; G06Q 20/40

(52) U.S. Cl. CPC G06Q 20/341; G06Q 20/3821; G06Q 20/40; G06Q 20/20; G06Q 20/322

(57) ABSTRACT

A method for sharing transaction data includes: storing, inside a point of sale device, a removable integrated circuit payment card, the card being configured to store payment credentials associated with a payment account and including an antenna configured to operate using electric power provided by the point of sale device; receiving, by a receiver of the integrated circuit payment card, transaction data for a payment transaction; encrypting, by a processor of the integrated circuit payment card, the received transaction data; receiving, by the receiver of the integrated circuit payment card, an indication of receipt of an authorization response associated with the payment transaction; and transmitting, by the antenna, the encrypted transaction data to a mobile communication device.

### FIELD

The present disclosure relates to the sharing and aggregation of transaction data, specifically the aggregation of transaction data on a mobile computing device received via transmission from an integrated circuit payment card used to conduct the payment transaction.

### BACKGROUND

For many years, a number of consumers have kept track of their payment transactions. Consumers have used ledgers, registers, books, and, more recently, spreadsheets and computer applications for keeping track of payment transactions, such as to manage personal budgets and to detect fraud. In more recent times, application programs often rely on communications with issuing banks in order to obtain account and transaction information for consumers, many times by using login information for the issuing bank's website as provided by the consumer.

However, such methods often require a consumer to first sign up with their issuing bank, sign up with the application's service, provide their private login credentials for their issuing bank to the service, and verify access of the application service to their account with the issuing bank. Such a process can be time consuming and very cumbersome for consumers, which may discourage consumers from joining, and may also discourage consumers for security reasons due to the requirement to divulge their personal login information. Further, such account and transaction history provided by such services is often done at periodic intervals or when prompted by the consumer, and thus may not provide data in real time, which may result in increased risk of fraud.

Thus, there is a need for a technical solution to provide for tracking of consumer transactions in real time that requires a minimal amount of consumer interaction and maintains consumer privacy and security.

### SUMMARY

The present disclosure provides a description of systems and methods for the sharing and aggregation of transaction data using an integrated circuit payment card.

A method for sharing transaction data includes: storing, inside a point of sale device, a removable integrated circuit payment card, wherein the integrated circuit payment card is configured to store payment credentials associated with a payment account and includes an antenna configured to operate using electric power provided by the point of sale device; receiving, by a receiver of the integrated circuit payment card, transaction data for a payment transaction; encrypting, by a processor of the integrated circuit payment card, the received transaction data; receiving, by the receiver of the integrated circuit payment card, an indication of receipt of an authorization response associated with the payment transaction; and transmitting, by the antenna, the encrypted transaction data to a mobile communication device.

A method for aggregating transaction data includes: storing, in a memory, transaction data for a plurality of payment transactions; receiving, by a receiving device, encrypted transaction data for a new payment transaction from an antenna of a removable integrated circuit payment card; decrypting, by a processing device, the received encrypted transaction data to obtain unencrypted transaction data; storing, in the memory, the unencrypted transaction data; and displaying, by a display device, the stored transaction data for the plurality of payment transactions and the stored unencrypted transaction data for the new payment transaction.

A system for sharing transaction data includes a point of sale device and a removable integrated circuit payment card. The point of sale device is configured to store the removable integrated circuit payment card. The integrated circuit payment card is configured to store payment credentials associated with a payment account and includes: an antenna configured to operate using electric power provided by the point of sale device; a receiver configured to receive transaction data for a payment transaction; and a processor configured to encrypt the received transaction data. The receiver of the integrated circuit payment card is further configured to receive an indication of receipt of an authorization response associated with the payment transaction. The antenna is further configured to transmit the encrypted transaction data to a mobile communication device.

A system for aggregating transaction data includes a memory, a receiving device, a processing device, and a display device. The memory is configured to store transaction data for a plurality of payment transactions. The receiving device is configured to receive encrypted transaction data for a new payment transaction from an antenna of a removable integrated circuit payment card. The processing device is configured to: decrypt the received encrypted transaction data to obtain unencrypted transaction data; and store, in the memory, the unencrypted transaction data. The display device is configured to display the stored transaction data for the plurality of payment transactions and the stored unencrypted transaction data for the new payment transaction.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for sharing and aggregating transaction data in accordance with exemplary embodiments.

FIG. 2 is a block diagram illustrating the integrated circuit payment card of FIG. 1 for the sharing of transaction data in accordance with exemplary embodiments.

FIG. 3 is a block diagram illustrating the mobile computing device of FIG. 1 for the aggregation of transaction data in accordance with exemplary embodiments.

FIG. 4 is a flow diagram illustrating a process for the sharing and aggregation of transaction data using the system of FIG. 1 in accordance with exemplary embodiments.

FIG. 5 is a flow chart illustrating a process for sharing transaction data using the integrated circuit payment card of FIG. 2 in accordance with exemplary embodiments.

FIG. 6 is a flow chart illustrating a process for aggregating transaction data using the mobile communication device of FIG. 3 in accordance with exemplary embodiments.

FIG. 7 is a flow chart illustrating an exemplary method for sharing transaction data in accordance with exemplary embodiments.

FIG. 8 is a flow chart illustrating an exemplary method for aggregating transaction data in accordance with exemplary embodiments.

FIG. 9 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

Integrated Circuit Payment Card—A payment card that is embedded with an integrated circuit. Integrated circuit payment cards may also be known as smart cards, chip cards, EMV (Europay, MasterCard, VISA) cards, contactless cards, and other names used to represent payment cards embedded with an integrated circuit.

### System for Sharing and Aggregating Transaction Data

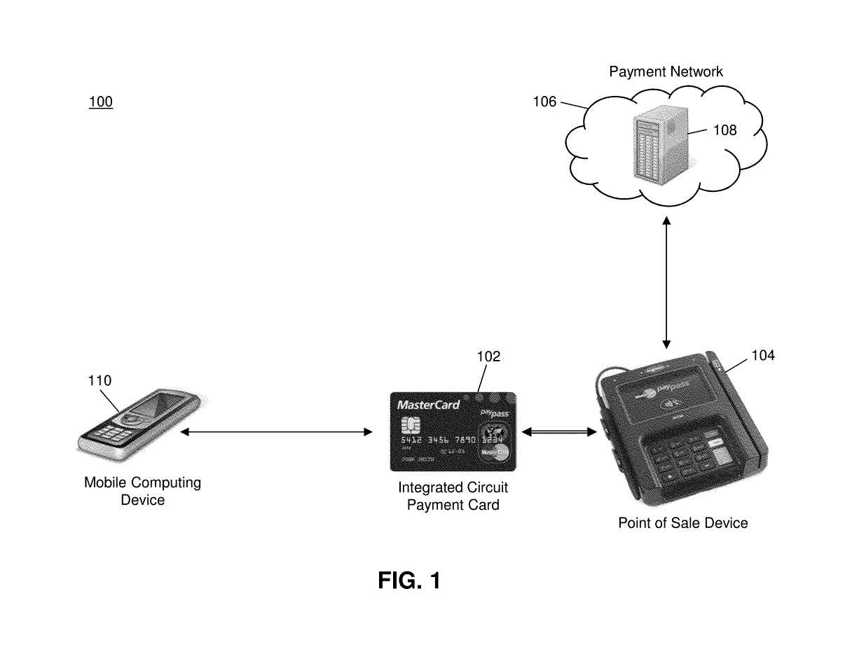

FIG. 1 illustrates a system 100 for the sharing and aggregation of transaction data via the use of an integrated circuit payment card.

The system 100 may include an integrated circuit payment card 102. The integrated circuit payment card 102, as discussed in more detail below, may store payment details associated with a payment account held by a consumer. The integrated circuit payment card 102 may be inserted into a point of sale device 104 during the conducting of a payment transaction for the purchase of goods or services. The point of sale device 104 may read the payment details stored in the integrated circuit payment card 102 using methods and systems that will be apparent to persons having skill in the relevant art.

Once the payment details have been read and the transaction is ready to be processed, the point of sale device 104 may transmit transaction details for the payment transaction to a payment network 106 for processing. The transaction details may be included in an authorization request, which may be generated by the point of sale device 104 or another system, such as a computing system of an acquiring bank associated with a merchant operating the point of sale device 104. The payment network 106 may process the payment transaction using methods and systems that will be apparent to persons having skill in the relevant art.

The payment network 106 may include one or more processing servers 108. The processing server 108 may be configured to process the payment transaction using suitable methods and generate and transmit an authorization response to the point of sale device 104 indicating approval or denial of the payment transaction. In some instances, the processing server 108 may store transaction data for the payment transaction, such as in a local transaction database.

The point of sale device 104 may receive the authorization response that indicates approval or denial of the payment transaction. An employee and consumer involved in the payment transaction may view the authorization response or an indication thereof via the point of sale device 104, and may finalize the transaction.

The integrated circuit payment card 102 may include an antenna embedded in the payment card. In some embodiments, the antenna may be a passive antenna that operates using electric power provided by the point of sale device 104. The integrated circuit payment card 102 may receive data indicating that the authorization response has been received by the point of sale device 104, and then may transmit a message to a nearby mobile computing device 110 using the embedded antenna.

The mobile computing device 110 may be associated with a consumer that is also associated with the integrated circuit payment card 102. The mobile computing device 110 may receive the message from the integrated circuit payment card 102, which may include transaction data and any other suitable data associated with the payment transaction. In some instances, the data included in the message may be based on the content of the authorization response. For example, if the authorization response indicates approval of the payment transaction, the data may include transaction data, such as the transaction amount, transaction time and/or date, merchant name, etc. In some cases, the included data may be set by the consumer. In another example, if the authorization response indicates denial of the payment transaction, the message may include data indicating a reason for the denial, such as an incorrect personal identification number was provided, there were insufficient funds in the account, etc.

The mobile computing device 110, discussed in more detail below, may receive the message and/or transaction data and may store the transaction data locally in the device. The consumer may then use the mobile computing device 110 to view the transaction data for the payment transaction and for other payment transactions conducted using the integrated circuit payment card 102 whose data was provided to the mobile computing device 110 by the integrated circuit payment card 102. In some embodiments, the mobile computing device 110 may also receive transaction data for additional payment transactions associated with the consumer, such as via other payment accounts and/or other integrated circuit payment cards 102. In such an embodiment, the mobile computing device 110 may aggregate all of the transaction data for view by the user, using methods and systems that will be apparent to persons having skill in the relevant art.

In some embodiments, the integrated circuit payment card 102 may encrypt the transaction data prior to transmission to the mobile computing device 110 using known or new encryption techniques. The mobile computing device 110 may receive the encrypted data, and may decrypt the data using methods and systems that will be apparent to persons having skill in the relevant art. In such an embodiment, the transaction data transmitted to the mobile computing device 110 may be more secure, as any additional devices that may pick up the transmission may be unable to decrypt, and thereby analyze, the data.

The use of the integrated circuit payment card 102 to share transaction data for aggregation on the mobile computing device 110 may provide a number of advantages over existing systems. As the integrated circuit payment card 102 is inserted in the point of sale device 104 used to conduct the payment transaction, the integrated circuit payment card 102 may receive the transaction data for the payment transaction prior to any other system or device. As a result, the integrated circuit payment card 102 may be able to provide the transaction data to the mobile computing device 110 in real-time, and much faster than using traditional systems.

In addition, such a system for aggregating transaction data may be more convenient for consumers. As the transaction data may be provided directly from the point of sale device 104 to the mobile computing device 110 by the integrated circuit payment card 102, the consumer may obtain a record of payment transactions without the need to use third party services, provide secure login information, or retrieve the transactions from a plurality of different issuers, websites, or application programs. As a result, the system 100 may be more convenient, and thus more accommodating, to consumers than traditional systems used for aggregating transaction data.

### Integrated Circuit Payment Card

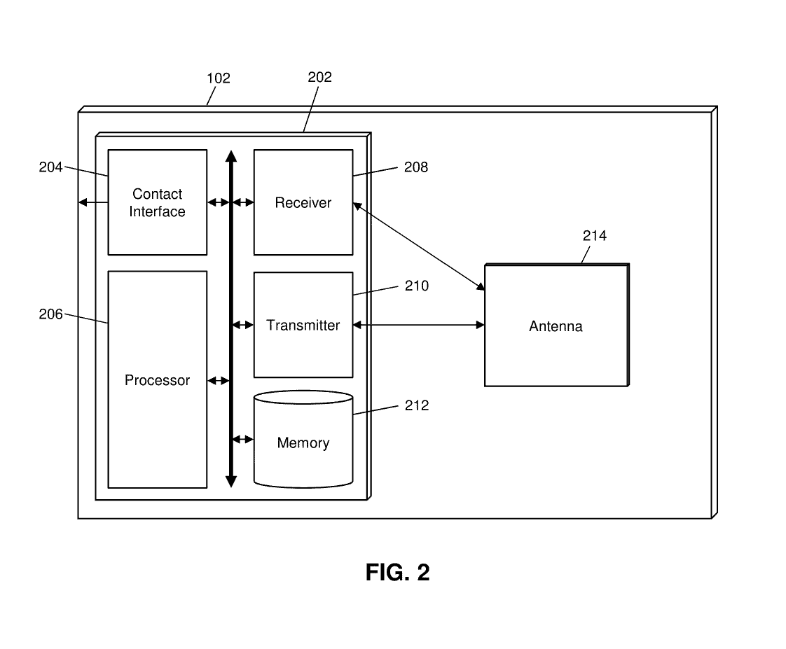

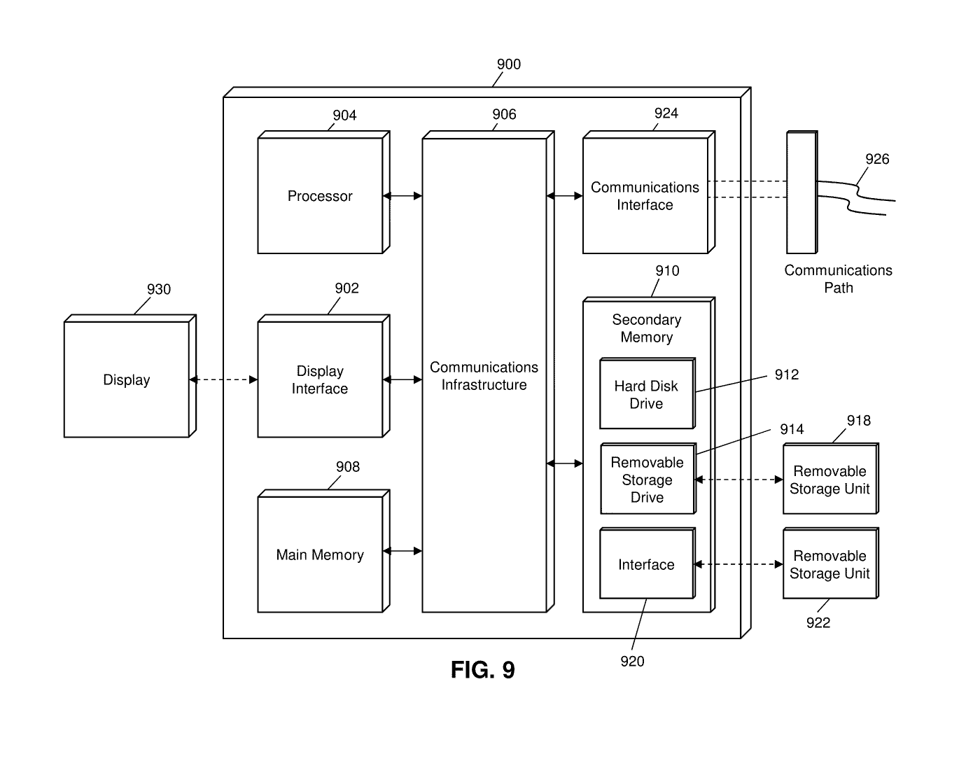

FIG. 2 illustrates an embodiment of the integrated circuit payment card 102 of the system 100. It will be apparent to persons having skill in the relevant art that the embodiment of the integrated circuit payment card 102 illustrated in FIG. 2 is provided as illustration only and may not be exhaustive to all possible configurations of the integrated circuit payment card 102 suitable for performing the functions as discussed herein. For example, the computer system 900 illustrated in FIG. 9 and discussed in more detail below may be a suitable configuration of the integrated circuit payment card 102.

The integrated circuit payment card 102 may include an integrated circuit 202. The integrated circuit 202 may include a plurality of computing components suitable for performing the functions as disclosed herein and suitable for performing the necessary functions of an integrated circuit payment card for conducting payment transactions as will be apparent to persons having skill in the relevant art.

The integrated circuit 202 may include a contact interface 204. The contact interface 204 may be an interface suitable for communicating with the point of sale device 104, such as via a contact pad. The contact interface 204 may transfer data to and from the point of sale device 104. The contact interface 204 may be configured to operate via instructions provided by one or more components of the integrated circuit 202, such as a receiver 208. The receiver 208 may be configured to instruct the contact interface 204 to receive data from the point of sale device 104, such as a request for payment details.

Data received by the receiver 208 via the contact interface 204 may be analyzed, identified, interpreted, etc. by a processor 206. The processor 206 may be configured to perform the functions of the integrated circuit 202 and integrated circuit payment card 102 as discussed herein, and may be further configured to perform the traditional functions of an integrated circuit payment card 102, such as providing of payment details to the point of sale device 104, as will be apparent to persons having skill in the relevant art.

The integrated circuit 202 may also include a memory 212. The memory 212 may be configured to store data suitable for performing the functions as discussed herein, and data suitable for performing the traditional functions of an integrated circuit payment card 102, such as payment details associated with the payment account associated with the integrated circuit payment card 102.

The receiver 208 of the integrated circuit 202 may be configured to receive transaction data from the point of sale device 104. It may also be able to receive transmissions from an antenna 214. In some instances, the transaction data may include an indication of receipt of an authorization response from the point of sale device 104. The transaction data may be stored in the memory 212 prior to transmission to the mobile computing device 110. Once the indication of receipt of an authorization response has been received by the receiver 208, the processor 206 may be configured to generate a message including the transaction data for transmission to the mobile computing device 110. In some embodiments, the processor 206 may encrypt the message using methods and systems that will be apparent to persons having skill in the relevant art.

The integrated circuit 202 may include a transmitter 210, which may be separate from or combined with the receiver 208 to be a transceiver for two-way communications. The transmitter 210 may be configured to transmit data, such as the message generated by the processor 206. The transmitter 210 may transmit data to the mobile computing device 110 via the antenna 214 included in the integrated circuit payment card 102. The antenna 214 may be a passive antenna that is configured to operate using electric power provided by the point of sale device 104. The electric power may be provided via the contact interface 204, and the transmission may be emitted by an alternative source, such as via an antenna included in the point of sale device 104, or may be provided in any other suitable method. As illustrated, the message may be transmitted via the antenna 214 to the mobile computing device 110 using methods suitable for the transmission of data as will be apparent to persons having skill in the relevant art. For instance, the antenna 214 may be a radio frequency antenna and may transmit the message to the mobile computing device 110 using near field communication (NFC) or other suitable short range communication protocols (e.g., WiFi, ZigBee, etc.).

### Mobile Computing Device

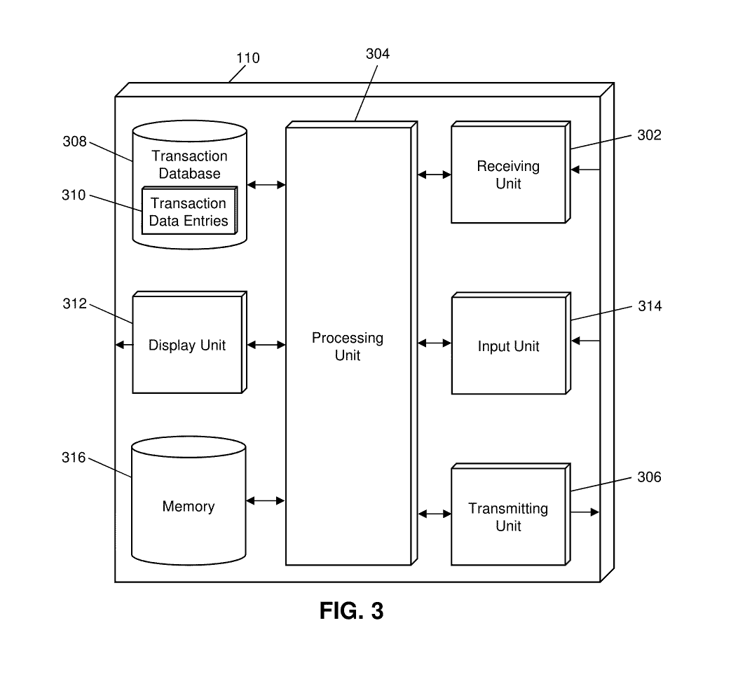

FIG. 3 illustrates an embodiment of the mobile computing device 110 of the system 100. It will be apparent to persons having skill in the relevant art that the embodiment of the integrated mobile computing device 110 in FIG. 3 is provided as illustration only and may not be exhaustive to all possible configurations of the mobile computing device 110 suitable for performing the functions as discussed herein. For example, the computer system 900 illustrated in FIG. 9 and discussed in more detail below may be a suitable configuration of the mobile computing device 110.

The mobile computing device 110 may include a receiving unit 302. The receiving unit 302 may be configured to receive data over one or more networks via one or more network protocols. The receiving unit 302 may receive an encrypted message including transaction data transmitted by the integrated circuit payment card 102.

The mobile computing device 110 may also include a processing unit 304. The processing unit 304 may be configured to decrypt the received message. The decryption may be performed using one or more decryption rules, algorithms, keys, etc., which may be stored in a memory 316 of the mobile computing device 110. Once the message has been decrypted, the processing unit 304 may store transaction data included therein in a transaction database 308 as a plurality of transaction data entries 310. Each transaction data entry 310 may include data related to a payment transaction including at least transaction data for the related payment transaction. The transaction data may include transaction amounts, transaction time and/or dates, merchant data, product data, geographic location data, and any other suitable data. In some embodiments, the transaction data obtained and/or stored in the transaction database 308 may be set by the consumer, such as via rules stored in the memory 316.

The mobile computing device 110 may also include a transmitting unit 306. The transmitting unit 306 may be configured to transmit data over one or more networks via one or more network protocols The transmitting unit 306 may be configured to transmit messages to establish communication with the integrated circuit payment card 102. The transmitting unit 306 may also be configured to transmit requests for additional transaction data, such as for payment transactions conducted by the consumer with other payment methods. For example, the request may be transmitted to the processing server 108 of the payment network 106. In such an embodiment, the receiving unit 302 may receive the additional transaction data for storage in the transaction database 308 by the processing unit 304.

The mobile computing device 110 may also include a display unit 312. The display unit 312 may be configured to display data to a user of the mobile computing device 110, such as the received and stored transaction data. The display unit 312 may be any type of display suitable for performing the functions disclosed herein, such as a liquid crystal display, light-emitting diode display, capacitive touch display, thin film transistor display, etc. Data may be display using the display unit 312 via an application program, which may be stored in the memory 316 as application data and executed by the processing unit 304.

The mobile computing device 110 may also include an input unit 314. The input unit 314 may be configured to receive input from a user of the mobile computing device 110, such as to initiate communication with the integrated circuit payment card 102, to review transaction data, to execute an application program to view transaction data, etc. The input unit 314 may be any type of input unit suitable for performing the functions disclosed herein, such as a keyboard, mouse, touch screen, click wheel, scroll wheel, microphone, camera, etc.

### Process for Sharing and Aggregating Transaction Data

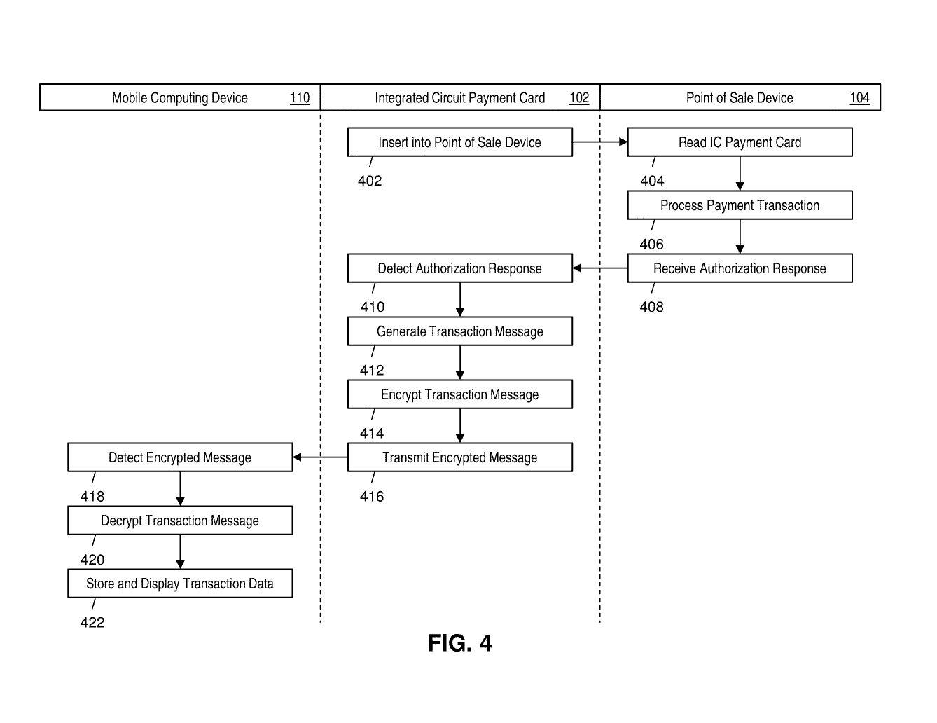

FIG. 4 illustrates a process for the sharing and aggregation of transaction data using the system 100 of FIG. 1, which may be part of a larger authentication, authorization and/or approval process.

In step 402, the integrated circuit payment card 102 may be inserted into the point of sale device 104. As part of the insertion, the integrated circuit payment card 102 and point of sale device 104 may initiate communications, such as using the contact interface 204 of the integrated circuit 202 of the integrated circuit payment card 102. In step 404, the point of sale device 104 may read data stored in the memory 212 of the integrated circuit payment card 102, such as the payment details for the payment transaction being conducted.

In step 406, the point of sale device 104 may process the payment transaction using methods and systems that will be apparent to persons having skill in the relevant art. As part of the processing of the payment transaction, in step 408 the point of sale device 104 may receive an authorization response from the payment network 106. The authorization response may include at least an indication of the approval or denial of the payment transaction.

In step 410, the integrated circuit payment card 102 may detect the receipt of the authorization response by the point of sale device 104. In some embodiments, the detection may be via the receipt of the authorization response or indication thereof by the receiver 208 of the integrated circuit 202 of the integrated circuit payment card 102 from the point of sale device 104. In some instances, the indication may include the transaction data. In other instances, the transmitter 210 may request transaction data from the point of sale device 104, which may be received by the receiver 208 and stored in the memory 212.

In step 412, the processor 206 of the integrated circuit 202 of the integrated circuit payment card 102 may generate a transaction message, which may include the transaction data, the indication of approval or denial of the payment transaction, and/or any other suitable data. In step 414, the processor 206 may encrypt the transaction message using one or more methods of encryption. In step 416, the transmitter 210 of the integrated circuit payment card 102 may transmit the encrypted transaction message to the mobile computing device 110 using the antenna 214 powered by electric power from the point of sale device 104.

In step 418, the receiving unit 302 of the mobile computing device 110 may detect (e.g., receive) the encrypted message from the integrated circuit payment card 102. In step 420, the processing unit 304 of the mobile computing device 110 may decrypt the transaction message to obtain the data included therein. In step 422, the mobile computing device 110 may store the received transaction data as a transaction data entry 310 in the transaction database 308 and make the data available for viewing by the user via the display unit 312. In embodiments where the transaction message may include a message for display rather than transaction data, such as a message indicating a reason for denial of the payment transaction, the message may be displayed by the display unit 312 without storage in the transaction database 308 and/or memory 316.

### Process for Sharing Transaction Data

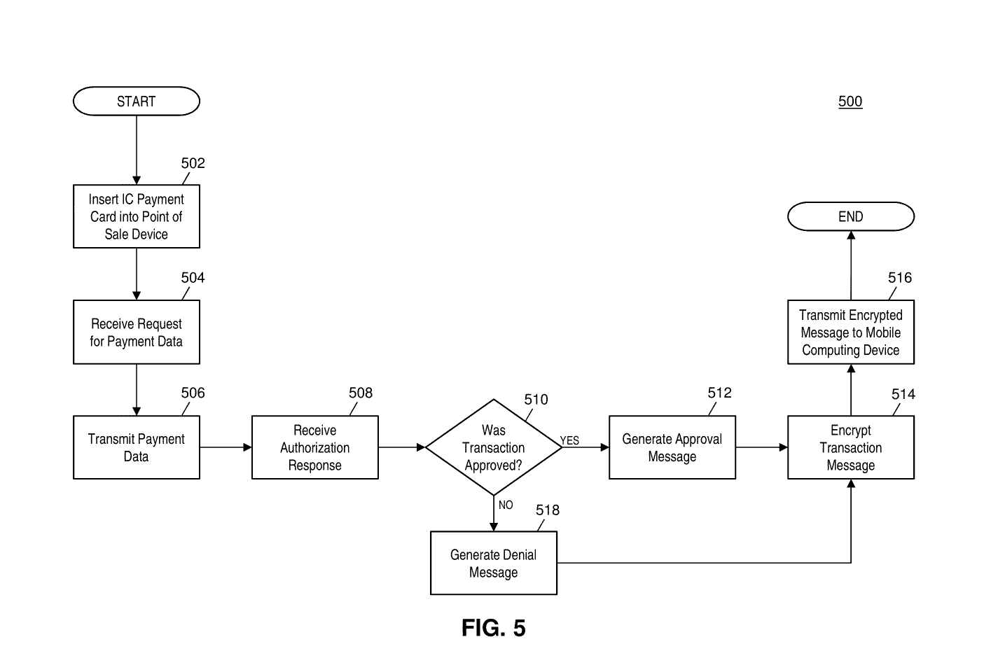

FIG. 5 illustrates a process 500 for the real time sharing of transaction data by the integrated circuit payment card 102.

In step 502, the integrated circuit payment card 102 may be inserted into the point of sale device 104 and communication established between the point of sale device 104 and the integrated circuit payment card 102 via the contact interface 204 of the integrated circuit 202. In step 504, the receiver 208 of the integrated circuit 202 may receive a request for payment data from the point of sale device 104. The processor 206 of the integrated circuit 202 may identify the requested payment data in the memory 212, which may be transmitted by the transmitter 210 to the point of sale device 104, in step 506.

In step 508, the receiver 208 may receive an authorization response or indication thereof from the point of sale device 104 for the payment transaction for which the payment details were requested. In some embodiments, the authorization response may include transaction data for the payment transaction. In a further embodiment, the transaction data may only be included if the authorization response indicates approval of the payment transaction.

In step 510, the processor 206 of the integrated circuit 202 may determine if the transaction was approved based on data included in the authorization response or indication thereof. If the transaction was approved, then, in step 512, the processor 206 may generate an approval message. The approval message may include at least an indication that the payment transaction was approved, and transaction data for storage in the mobile computing device 110 and display to a user. In some instances, generating the approval message may include requesting transaction details from the point of sale device 104 and receipt thereof for inclusion in the message.

In step 514, the processor 206 may encrypt the generated transaction message. In step 516, the transmitter 210 of the integrated circuit 202 of the integrated circuit payment card 102 may transmit the encrypted message to the mobile computing device 110.

If, in step 510, the processor 206 determines that the payment transaction was denied, then, in step 518, the processor 206 may generate a denial message. The denial message may include an indication that the payment transaction was denied, and may further include a reasoning or explanation, such as provided in the authorization response or indication thereof forwarded by the point of sale device 104. For example, the denial message may include a message that the transaction was denied due to a lack of available funds. The process may then proceed to step 514, where the denial message may be encrypted, and then to step 516, where the encrypted message may be transmitted to the mobile computing device 110.

### Process for Aggregating Transaction Data

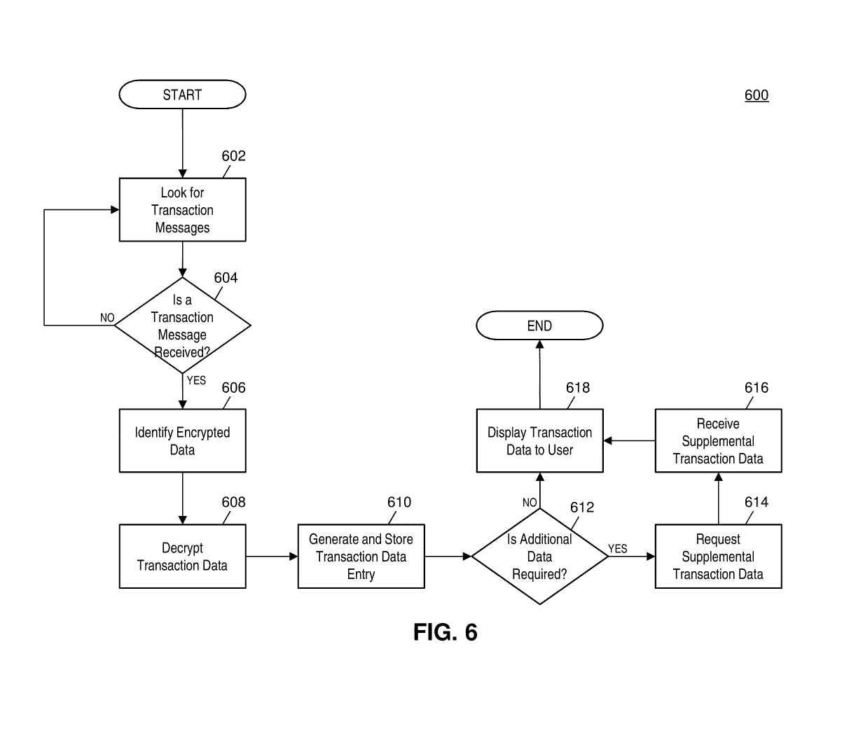

FIG. 6 illustrates a process 600 for the real time aggregation of transaction data in the mobile computing device 110 as provided by the integrated circuit payment card 102.

In step 602, the receiving unit 302 of the mobile computing device 110 may monitor for transaction messages being emitted by the integrated circuit payment card 102. In some embodiments, step 602 may be initiated by a user of the mobile computing device 110, such as, for instance, by the execution of an application program stored in the mobile computing device 110. In step 604, the processing unit 304 of the mobile computing device 110 may evaluate to see if any transaction messages have been received by the receiving unit 302. If no messages have been received, then the process may return to step 602 where monitoring for messages may continue.

Once a message has been received, then, in step 606, the processing unit 304 may identify encrypted data included in the received transaction message. In step 608, the processing unit 304 may decrypt the encrypted data to obtain transaction data included therein, such as by using a decryption key and/or algorithm stored in the memory 316 of the mobile computing device 110. In step 610, the processing unit 304 may generate a transaction data entry 310 including the transaction data and store the generated entry in the transaction database 308 of the mobile computing device 110.

In step 612, the processing unit 304 may determine if additional transaction data regarding the payment transaction is required. If additional data is required, then, in step 614, the transmitting unit 306 may transmit a request for supplemental transaction data. In some embodiments, the request may be transmitted to the processing server 108 of the payment network 106. In other embodiments, the request may be transmitted to the integrated circuit payment card 102. In some instances, the request may specify the additional transaction data being requested, such as based on input received from the input unit 314 from the user.

In step 616, the receiving unit 302 may receive the requested supplemental transaction data as a response to the transmitted request. Once the supplemental data has been received, or if no additional data was required at step 612, then, in step 618, the display unit 312 of the mobile computing device 110 may display the transaction data for the payment transaction to the user.

### Exemplary Method for Sharing Transaction Data

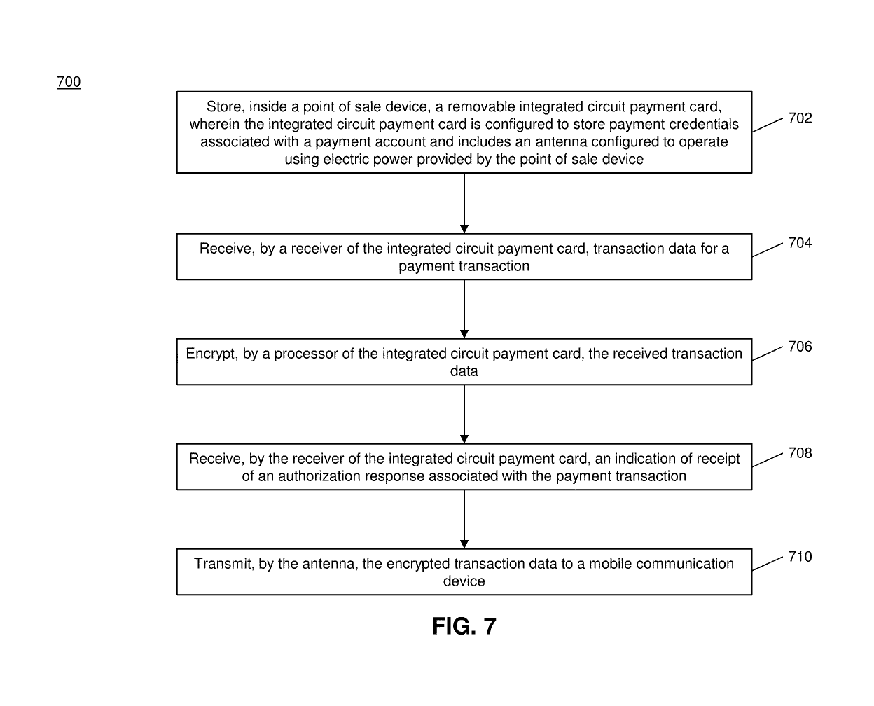

FIG. 7 illustrates a method 700 for the sharing of transaction data in real time to a mobile computing device from an integrated circuit payment card.

In step 702, a removable integrated circuit payment card (e.g., the integrated circuit payment card 102) may be stored inside a point of sale device (e.g., the point of sale device 104), wherein the integrated circuit payment card 102 is configured to store payment credentials associated with a payment account and includes an antenna (e.g., the antenna 214) configured to operate using electric power provided by the point of sale device 104. In one embodiment, the antenna 214 may be a radio frequency antenna.

In step 704, a receiver (e.g., the receiver 208) of the integrated circuit payment card 102 may receive transaction data for a payment transaction. In some embodiments, the transaction data may include at least one of: transaction amount, transaction time and/or date, merchant name, merchant category, merchant industry, product data, and user-supplied data.

In step 706, the received transaction data may be encrypted by a processor (e.g., the processor 206) of the integrated circuit payment card 102. In some embodiments, the removable integrated circuit payment card 102 may include an integrated circuit (e.g., the integrated circuit 202) including at least the receiver 208 and the processor 206.

In step 708, an indication of receipt of an authorization response associated with the payment transaction may be received by the receiver 208 of the integrated circuit payment card 102. In some embodiments, the transaction data for the payment transaction may be received after the indication of receipt of an authorization response. In step 710, the antenna 214 may transmit the encrypted transaction data to a mobile communication device (e.g., the mobile computing device 110).

### Exemplary Method for Aggregating Transaction Data

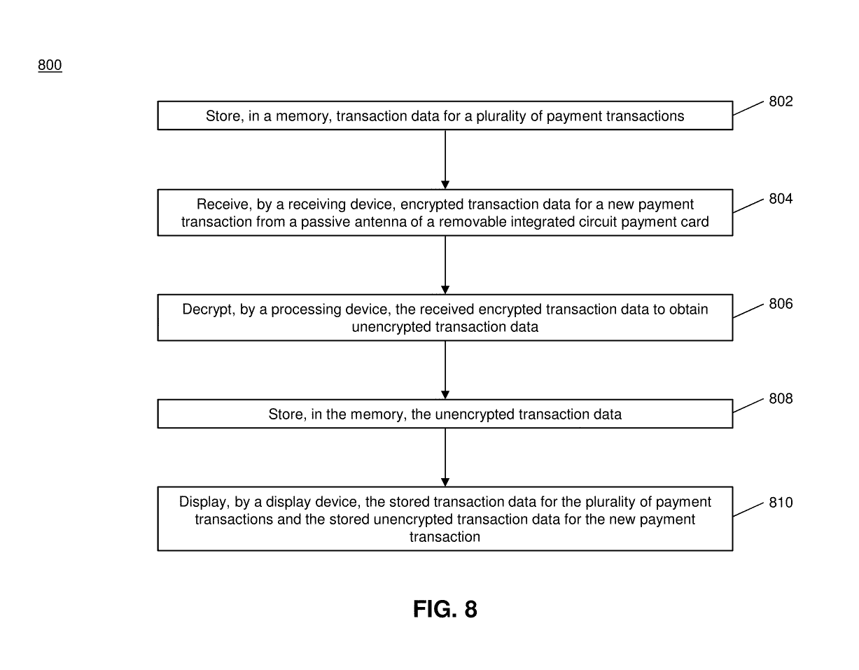

FIG. 8 illustrates a method 800 for the aggregation of transaction data in real time on a mobile computing device as received from an integrated circuit payment card.

In step 802, transaction data for a plurality of payment transactions may be stored in a memory (e.g., the transaction database 308). In some embodiments, the plurality of payment transactions may be associated with more than one payment account.

In step 804, encrypted transaction data for a new payment transaction may be received by a receiving device (e.g., the receiving unit 302) from a passive antenna (e.g., the antenna 214) of a removable integrated circuit payment card (e.g., the integrated circuit payment card 102). In one embodiment, the antenna 214 may be a radio frequency antenna. In some embodiments, the transaction data may include at least one of: transaction amount, transaction time and/or date, merchant name, merchant category, merchant industry, product data, and user-supplied data. In one embodiment, the antenna 214 of the removable integrated circuit payment card 102 may be powered by a point of sale device (e.g., the point of sale device 104) storing the removable integrated circuit payment card 102.

In step 806, the received encrypted transaction data may be decrypted by a processing device (e.g., the processing unit 304) to obtain unencrypted transaction data. In step 808, the unencrypted transaction data may be stored in the memory. In step 810, the stored transaction data for the plurality of payment transactions and the stored unencrypted transaction data for the new payment transaction may be displayed by a display device (e.g., the display unit 312).

### Computer System Architecture

FIG. 9 illustrates a computer system 900 in which embodiments of the present disclosure, or portions thereof, may be implemented as computer-readable code. For example, the integrated circuit payment card 102 and the mobile computing device 110 of FIG. 1 may be implemented in the computer system 900 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4-8.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 918, a removable storage unit 922, and a hard disk installed in hard disk drive 912.

Various embodiments of the present disclosure are described in terms of this example computer system 900. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 904 may be a special purpose or a general purpose processor device. The processor device 904 may be connected to a communications infrastructure 906, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 900 may also include a main memory 908 (e.g., random access memory, read-only memory, etc.), and may also include a secondary memory 910. The secondary memory 910 may include the hard disk drive 912 and a removable storage drive 914, such as a floppy disk drive, a magnetic tape drive, an optical disk drive, a flash memory, etc.

The removable storage drive 914 may read from and/or write to the removable storage unit 918 in a well-known manner. The removable storage unit 918 may include a removable storage media that may be read by and written to by the removable storage drive 914. For example, if the removable storage drive 914 is a floppy disk drive or universal serial bus port, the removable storage unit 918 may be a floppy disk or portable flash drive, respectively. In one embodiment, the removable storage unit 918 may be non-transitory computer readable recording media.

In some embodiments, the secondary memory 910 may include alternative means for allowing computer programs or other instructions to be loaded into the computer system 900, for example, the removable storage unit 922 and an interface 920. Examples of such means may include a program cartridge and cartridge interface (e.g., as found in video game systems), a removable memory chip (e.g., EEPROM, PROM, etc.) and associated socket, and other removable storage units 922 and interfaces 920 as will be apparent to persons having skill in the relevant art.

Data stored in the computer system 900 (e.g., in the main memory 908 and/or the secondary memory 910) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 900 may also include a communications interface 924. The communications interface 924 may be configured to allow software and data to be transferred between the computer system 900 and external devices. Exemplary communications interfaces 924 may include a modem, a network interface (e.g., an Ethernet card), a communications port, a PCMCIA slot and card, etc. Software and data transferred via the communications interface 924 may be in the form of signals, which may be electronic, electromagnetic, optical, or other signals as will be apparent to persons having skill in the relevant art. The signals may travel via a communications path 926, which may be configured to carry the signals and may be implemented using wire, cable, fiber optics, a phone line, a cellular phone link, a radio frequency link, etc.

The computer system 900 may further include a display interface 902. The display interface 902 may be configured to allow data to be transferred between the computer system 900 and external display 930. Exemplary display interfaces 902 may include high-definition multimedia interface (HDMI), digital visual interface (DVI), video graphics array (VGA), etc. The display 930 may be any suitable type of display for displaying data transmitted via the display interface 902 of the computer system 900, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 908 and secondary memory 910, which may be memory semiconductors (e.g., DRAMs, etc.). These computer program products may be means for providing software to the computer system 900. Computer programs (e.g., computer control logic) may be stored in the main memory 908 and/or the secondary memory 910. Computer programs may also be received via the communications interface 924. Such computer programs, when executed, may enable computer system 900 to implement the present methods as discussed herein. In particular, the computer programs, when executed, may enable processor device 904 to implement the methods illustrated by FIGS. 4-8, as discussed herein. Accordingly, such computer programs may represent controllers of the computer system 900. Where the present disclosure is implemented using software, the software may be stored in a computer program product and loaded into the computer system 900 using the removable storage drive 914, interface 920, and hard disk drive 912, or communications interface 924.

Techniques consistent with the present disclosure provide, among other features, systems and methods for sharing and aggregating transaction data. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for sharing transaction data, comprising:
storing, inside a point of sale device, a removable integrated circuit payment card, wherein the integrated circuit payment card is configured to store payment credentials associated with a payment account and includes an antenna configured to operate using electric power provided by the point of sale device;
receiving, by a receiver of the integrated circuit payment card, transaction data for a payment transaction;
encrypting, by a processor of the integrated circuit payment card, the received transaction data;
receiving, by the receiver of the integrated circuit payment card, an indication of receipt of an authorization response associated with the payment transaction; and
transmitting, by the antenna, the encrypted transaction data to a mobile communication device.

2. The method of claim 1, wherein the antenna is a radio frequency antenna.

3. The method of claim 1, wherein the transaction data includes at least one of: transaction amount, transaction time and/or date, merchant name, merchant category, merchant industry, product data, and user-supplied data.

4. The method of claim 1, wherein the transaction data for the payment transaction is received after the indication of receipt of an authorization response.

5. The method of claim 1, wherein the removable integrated circuit payment card includes an integrated circuit including at least the receiver and the processor.

6. A method for aggregating transaction data, comprising:
storing, in a memory, transaction data for a plurality of payment transactions;
receiving, by a receiving device, encrypted transaction data for a new payment transaction from an antenna of a removable integrated circuit payment card;
decrypting, by a processing device, the received encrypted transaction data to obtain unencrypted transaction data;
storing, in the memory, the unencrypted transaction data; and
displaying, by a display device, the stored transaction data for the plurality of payment transactions and the stored unencrypted transaction data for the new payment transaction.

7. The method of claim 6, wherein the antenna is a radio frequency antenna.

8. The method of claim 6, wherein the transaction data includes at least one of: transaction amount, transaction time and/or date, merchant name, merchant category, merchant industry, product data, and user-supplied data.

9. The method of claim 6, wherein the plurality of payment transactions are associated with more than one payment account.

10. The method of claim 6, wherein the antenna of the removable integrated circuit payment card is powered by a point of sale device storing the removable integrated circuit payment card.

11. A system for sharing transaction data, comprising:
a point of sale device configured to store a removable integrated circuit payment card, wherein
the integrated circuit payment card is configured to store payment credentials associated with a payment account and includes
an antenna configured to operate using electric power provided by the point of sale device,
a receiver configured to receive transaction data for a payment transaction, and
a processor configured to encrypt the received transaction data,
the receiver of the integrated circuit payment card is further configured to receive an indication of receipt of an authorization response associated with the payment transaction, and
the antenna is further configured to transmit the encrypted transaction data to a mobile communication device.

12. The system of claim 11, wherein the antenna is a radio frequency antenna.

13. The system of claim 11, wherein the transaction data includes at least one of: transaction amount, transaction time and/or date, merchant name, merchant category, merchant industry, product data, and user-supplied data.

14. The system of claim 11, wherein the transaction data for the payment transaction is received after the indication of receipt of an authorization response.

15. The system of claim 11, wherein the removable integrated circuit payment card includes an integrated circuit including at least the receiver and the processor.

16. A system for aggregating transaction data, comprising:
a memory configured to store transaction data for a plurality of payment transactions;
a receiving device configured to receive encrypted transaction data for a new payment transaction from an antenna of a removable integrated circuit payment card;
a processing device configured to
decrypt the received encrypted transaction data to obtain unencrypted transaction data, and
store, in the memory, the unencrypted transaction data; and
a display device configured to display the stored transaction data for the plurality of payment transactions and the stored unencrypted transaction data for the new payment transaction.

17. The system of claim 16, wherein the antenna is a radio frequency antenna.

18. The system of claim 16, wherein the transaction data includes at least one of: transaction amount, transaction time and/or date, merchant name, merchant category, merchant industry, product data, and user-supplied data.

19. The system of claim 16, wherein the plurality of payment transactions are associated with more than one payment account.

20. The system of claim 16, wherein the antenna of the removable integrated circuit payment card is powered by a point of sale device storing the removable integrated circuit payment card.
